(19) United States
(12) Patent Application Publication
(10) Pub. No.: US 2002/0076109 A1
(43) Pub. Date: Jun. 20, 2002

(54) METHOD AND APPARATUS FOR CONTEXT SENSITIVE TEXT RECOGNITION

(76) Inventors: ANDY HERTZFELD, SUNNYVALE, CA (US); DARIN BENJAMIN ADLER, SHERMAN OAKS, CA (US)

Correspondence Address: SKJERVEN MORRILL MACPHERSON LLP, 25 METRO DRIVE, SUITE 700, SAN JOSE, CA, 95110, US

(21) Appl. No.: 09/237,284

(22) Filed: Jan. 25, 1999

(51) Int. Cl. G06K 9/72

(52) U.S. Cl. 382/229

(57) ABSTRACT

A method and apparatus for providing an interpreter that is operable to recognize whether text displayed on a display device belongs to a pre-defined type of text, and to present the user with an option for performing a context sensitive operation when an interpreter recognizes the input text as belonging to the pre-defined type of text. The input text is generated based on a user selecting text, a portion of text, an object, or a portion of an object displayed on a display device that is part of a computer system. Alternatively, an interpreter automatically recognizes when displayed text belongs to a pre-defined type of text. A wide variety of interpreters may be included, wherein each interpreter has at least one corresponding pre-defined type of text and at least one corresponding context sensitive operation. The user is presented with options for performing the corresponding context sensitive operation for each interpreter when the user input is recognized as corresponding to one or more pre-defined types of text.

### BACKGROUND OF THE INVENTION

1. Field of the Invention

This invention relates to the field of graphical user interfaces, and more particularly, to a system capable of recognizing pre-defined types of text and presenting options to a user for performing different tasks based on the type of text.

2. Description of the Related Art

Currently, highly portable microprocessor-based computer systems and personal communication systems (PCS) are gaining popularity. Such systems often include a wireless communication interface to a voice telephone network, a dial-up modem interface to transmit and receive data over a computer network such as the Internet, and/or a facsimile machine for transmitting and receiving document images using the dial-up modem and a telephone network. In order to view and manipulate information, the devices include operating system software and one or more application programs such as an electronic mail program for downloading, viewing, composing, and transmitting electronic mail messages, an Internet browser for accessing the Internet, and a dial-up connection program for accessing a telephone network for voice or data communication. Many other types of application programs are available and may be installed on these devices to perform a variety of tasks and increase user productivity. Notably, system software may include application programs, especially for commonly performed tasks.

In many instances, information is contained in a database on the system that is accessible by application programs. Further, a user may enter or receive information in one application that would be useful as input to another portion of the same application program or to an entirely different application program. For example, a user may receive a letter via electronic mail that contains a telephone and/or facsimile number along with a request for the user to contact or to fax information to the author of the letter. In order to do this, the user typically has to leave the electronic mail program to access another application program to dial the telephone or facsimile number. In order to increase user productivity, it is desirable to have an application program or system software that is capable of recognizing pre-defined types of text or objects as being the type of information that is input to a particular application program, and to present the user with the option to execute the other application program with the information as input. It is further desirable to provide an interface for the user to define a type of information, such as alphanumeric text or graphics objects, as an input category and to associate an application task with the category. This allows the user to customize the device to allow more ready access to commonly used applications, thereby saving time and reducing data entry requirements.

### SUMMARY

In one embodiment, the present invention provides a method that may be implemented in computer program instructions and distributed on a computer readable medium as a computer program product. The program instructions include at least one interpreter that is operable to recognize whether input text belongs to a predefined type of text, and to present the user with an option for performing a context sensitive operation when the interpreter recognizes the input text as belonging to the pre-defined type of text. In one embodiment, the input text is generated based on a user touching text, a portion of text, an object or a portion of an object displayed on a display device. In another embodiment, the input text is generated by the program instructions automatically scanning information presented on the display device to determine if it recognizes any of the information as corresponding to a pre-defined type of text.

In one embodiment, the program instructions include one or more custom interpreters in addition to the built-in interpreters. The custom interpreters recognize whether the input text belongs to a type of text pre-defined for the particular custom interpreter. This allows a wide variety of interpreters to be made available and further allows a user to customize the present invention for use in a particular industry and/or for commonly performed operations.

In another embodiment, the custom interpreters are executed prior to the built-in interpreters.

In another embodiment, the built-in interpreters are not executed when the custom interpreter recognizes the input text as pre-defined type of text.

In another embodiment, the program instructions include a plurality of custom interpreters and a plurality of built-in interpreters, wherein each custom interpreter and each built-in interpreter has a corresponding pre-defined type of text and one or more corresponding context sensitive operations. The program instructions present options for performing the corresponding context sensitive operation for each interpreter that recognizes the input text as the corresponding pre-defined type of text.

In another embodiment, the present invention is utilized in a computer system and the options are displayed in a pop-up window on a display device in the computer system.

In yet another embodiment, the pop-up window is displayed until the user closes it. This allows the user to select one of the options, perform desired functions with the corresponding context sensitive operation, and return to the pop-up window to select another option. In an alternate embodiment, the pop-up window is removed when the user selects one of the options.

The present invention includes a feature that presents an option to the user to enable and disable text recognition by the interpreters.

The foregoing has outlined rather broadly the objects, features, and technical advantages of the present invention so that the detailed description of the invention that follows may be better understood.

### BRIEF DESCRIPTION OF THE DRAWINGS

The present invention may be better understood, and its numerous objects, features, and advantages made apparent to those skilled in the art by referencing the accompanying drawings.

FIG. 1 is a block diagram of components included in a computer system.

FIG. 2 is a flowchart diagram of a method for context sensitive text recognition in accordance with the present invention.

FIG. 3 is an example of text on a display device with which the present invention for context sensitive text recognition may be utilized.

FIG. 4 is an example of a pop-up window generated in accordance with the present invention for context sensitive text recognition.

FIG. 5 is another example of a pop-up window generated in accordance with the present invention for context sensitive text recognition.

FIG. 6 is flowchart diagram of another method for context sensitive text recognition in accordance with the present invention.

FIG. 7 is flowchart diagram of another method for context sensitive text recognition in accordance with the present invention.

The use of the same reference symbols in different drawings indicates similar or identical items.

### DETAILED DESCRIPTION

The following sets forth a detailed description of the best contemplated mode for carrying out the invention. The description is intended to be illustrative of the invention and should not be taken to be limiting.

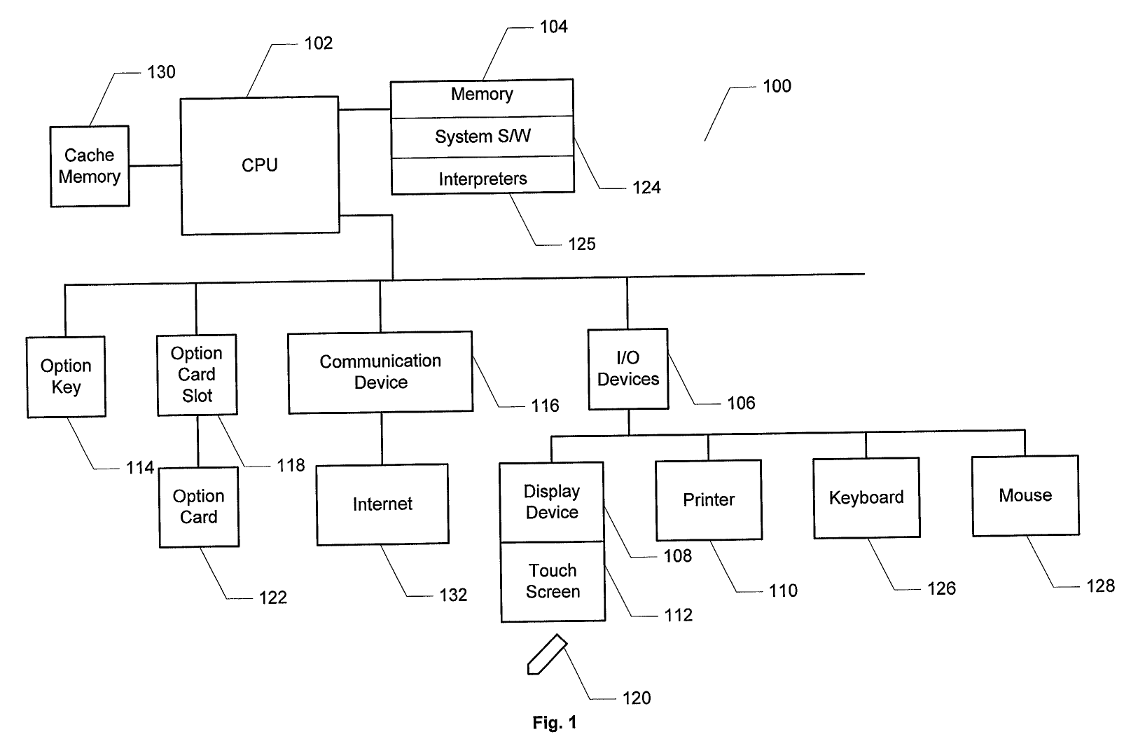

Referring now to FIG. 1, a diagram of components commonly included in computer system 100 within which the present invention may be utilized is shown.

Computer system 100 includes central processing unit (CPU) 102 which is coupled to memory 104, input/output (I/O) devices 106 such as display device 108, printer 110, and touch screen 112, and communication device 116. Memory 104 includes random access memory. Memory 104 also includes non-volatile memory such as read only memory or magnetic discs. CPU 102 can be constructed from one or more microprocessors and/or integrated circuits.

Display device 108 is, for example, a liquid crystal display (LCD) having 480 columns by 220 rows of pixels, each pixel being capable of displaying one of four levels of gray. Display device 108 may incorporate touch screen 112 which is a touch sensitive device that overlays display device 108 and provides signals to CPU 100 when it is physically touched by a touching device such as stylus 120 or by the finger of a user. The signals include signals indicating the coordinate location of display device 108 where the touch occurred.

While touch screen 112 is described herein as the position locator used with the present invention, any known position locator can be used in combination with display device 108 and with the present invention to provide a user interface to computer system 100. Other position locators which can be used with the present invention include mouse devices, trackball devices, thumbwheels, tablets, scanline sensitive stili, joysticks and radio-frequency digitizing devices. The term position locator refers to any device which can be used to indicate a position on the display screen.

Often the position indicated by a position locator corresponds to the location of a cursor which is displayed on the display device 108. However, with touch screen 112, the position corresponds to the location that is physically touched. Most position locators are operable in an actuated state and in a deactuated state. For example, mouse devices often include a mouse button, the pressing of which places the mouse device in an actuated state and the releasing of which places the mouse device in a deactuated state. Touch screen 112 is in an actuated state while touched and in a deactuated state while not touched.

Actuating a position locator, i.e., placing the position locator in an actuated state, while the position locator indicates the position at which an object is displayed in display device 108 is herein called touching the object. As used herein, the term “text” refers to alphanumeric characters, a portion of an alphanumeric character, an object, or a portion of an object presented on display device 108. The touching of text, which can be effected with any known position locating device, should not be confused with the physical touching of touch screen 112 which actuates touch screen 112 and indicates a point on display device 108. For example, text can be touched using a mouse device as a position locator by manipulating the mouse to indicate a position within display device 108 occupied by the text and actuating the mouse device. Touching text is also referred to herein as selecting text.

Memory 104 stores Magic Cap™ system software 124 which controls the operation of computer system 100. System software 124 includes groups of instructions which are organized as modules. During operation of system 100, CPU 102 retrieves the modules from memory 104 and executes the modules to perform tasks. Computer system software 124 includes modules which provide a graphical user interface to display device 108. One type of module included in system software 124 is one or more interpreters 125 for recognizing text, and presenting options to the user to execute application programs with the recognized text as input in accordance with the present invention.

Those skilled in the art will recognize that computer system 100 encompasses all types of computer systems including personal computers, midrange computers, mainframes, and hand-held personal communication systems. Note that many additions, modifications, and deletions can be made to this computer system 100 when used with the present invention. Computer system 100 may be one of many computer systems connected to a local area network (LAN), a wide area network (WAN), or a global information network such as the Internet 132.

While the present invention is described in the context of a fully functional computer system, those skilled in the art will appreciate that the present invention is capable of being distributed as a program product in a variety of forms, and that the present invention applies equally regardless of the particular type of signal bearing media used to actually carry out the distribution. Examples of signal bearing media include: recordable type media such as floppy disks and CD-ROM, transmission type media such as digital and analog communications links, as well as other known media storage and distribution systems.

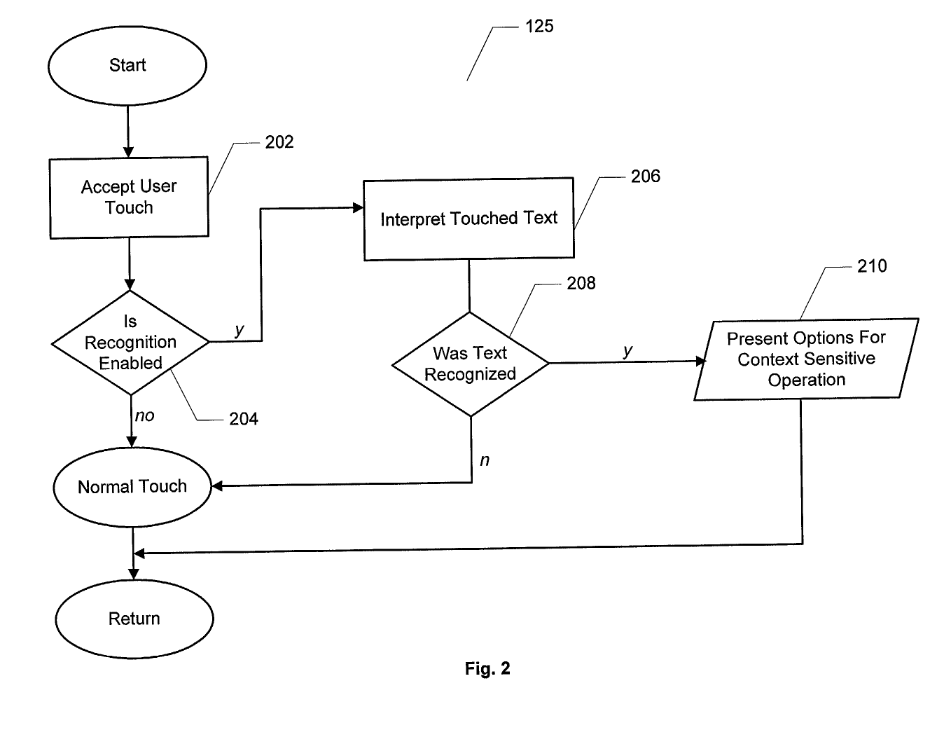

In one embodiment, the present invention is a method for assisting a user of a computer system in accessing various application programs. The method includes accepting input by the user, recognizing the input as text selection, determining whether text selected by the user belongs to a pre-defined type of text, and presenting options for tasks to perform based on the type of text. FIG. 2 shows an embodiment of an interpreter 125 according to the present invention wherein the user's touch is accepted in block 202. In the embodiment shown, the user may set an option to enable or disable text recognition. This option may be provided in a portion of system software 124 that allows the user to customize features, as known in the art. When recognition is enabled (block 205), the user's input is provided to one or more interpreters 125. Various types of interpreters may be included in system software 124, and a programmer may add additional interpreters 125 as desired.

Each interpreter 125 has knowledge of one or more pre-defined types of text, and includes logic for analyzing the touched text, and displayed information surrounding the touched text, to determine whether the touched text corresponds to one of the pre-defined types of text. The interpreter 125 may include any type of logic required to parse the touched text and information surrounding the touched text for one or more pre-defined types of text. Information surrounding touched text includes information above, below, before, and after Importantly, the user does not have to highlight or otherwise indicate the entire portion of the text to be recognized. For example, a user may touch a portion of the name of a city on display device 108. An interpreter 125 that includes geographic locations as a pre-defined type will examine portions of the text surrounding the selected text for spaces, punctuation marks, tabs, and other characters that delimit words for cities, states, countries, oceans, and continents, for example. Interpreter 125 compares the parsed word or words to a list of locations to determine if there is a match. When the text is matched, also referred to as “recognized” in block 208, Interpreter 125 presents one or more application programs the user may choose to execute with the recognized text as input. The application program, also referred to herein as a context sensitive operation, is presented as a selectable option in a list that is accessible by the user, such as a pop-up window, a pull-down menu, or a selectable icon.

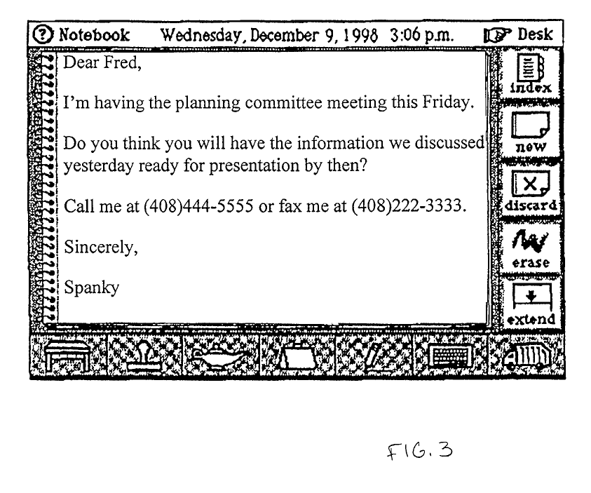

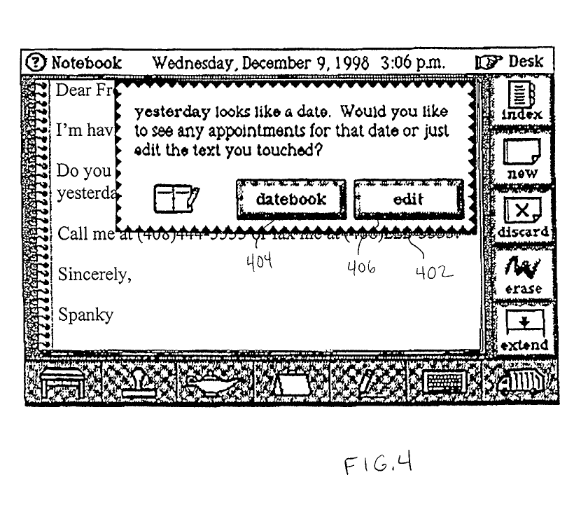

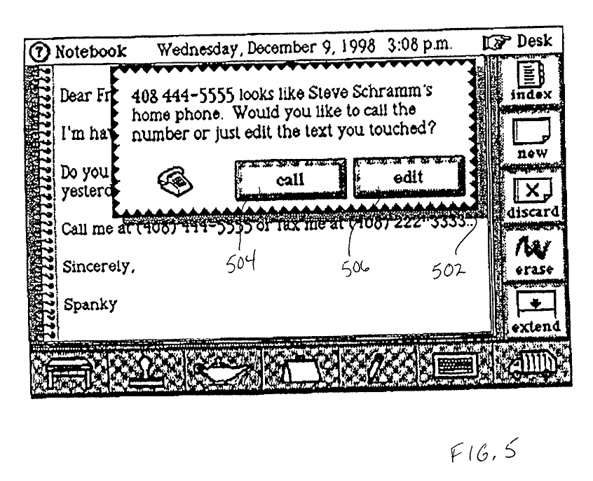

As an example of an embodiment of the present invention, FIGS. 3, 4, and 5 show a display of a notebook application that allows the user to compose and view memorandums, letters, and notes. FIG. 3 shows a letter as entered by the user. FIGS. 4 and 5 show two different examples of a pop-up window that is presented to the user when text is selected by a user and recognized by an interpreter 125. In FIG. 4, a user touched a portion of the word “yesterday” and system software 124 presents pop-up window 402 to the user after interpreter 125 parsed the text surrounding the touch portion and recognized the word “yesterday”. When the user touches datebook button 404, a datebook application program is executed, allowing the user to view, enter, and modify appointments, and perform any other functions included in the application program. Additionally, the present invention may present other application programs that use a date as input, giving the user a choice of applications. Alternatively, the user may also choose to edit the text by touching edit button 406.

FIG. 5 shows an example of a pop-up window 502 presented when the user touches a portion of a telephone number. Interpreter 125 parses the touched text and the portions surrounding the touched text, and recognizes the telephone number after comparing it to a database of address and telephone numbers. Note that the interpreter 125 may present additional information from the data base to the user, including the name of the person associated with the telephone number and the location of the telephone (i.e., home phone). When the user touches call button 504, interpreter 125 causes an application program which establishes a connection to a telephone network and dials the telephone number to be executed. Alternatively, the user may choose edit button 406 to remove pop-up window 402 and edit the text.

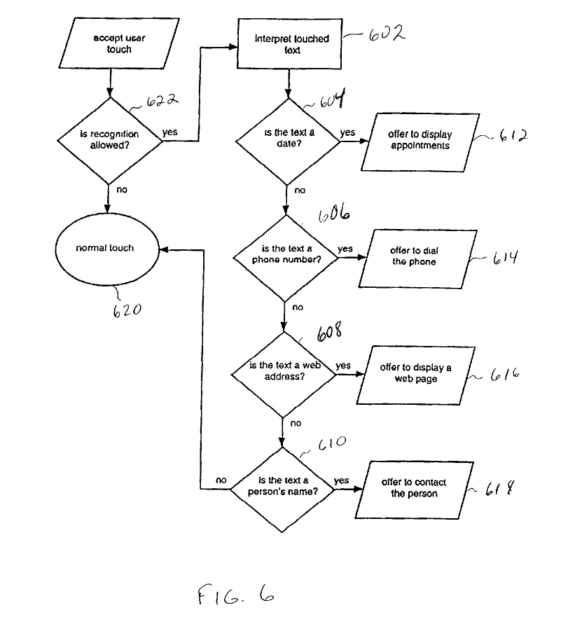

FIG. 6 shows a flowchart diagram of an embodiment of the present invention that executes an interpreter 125 in block 602 and then determines if the selected text is a date (block 604), a telephone number (block 606), a world wide web network address (block 608), or a person's name (block 610). When the selected text is recognized as one of those choices, a corresponding application program for displaying appointments (block 612), dialing a telephone (block 614), connecting to the Internet and displaying a page on the world wide web (block 616), or contacting a person (block 618), is executed. When the text is not recognized, the present invention accepts the input as a normal touch (block 620) and performs an action such as placing a cursor at the touched location for the user to edit the text.

Note that FIG. 6 also shows that interpreters 125 may be bypassed if text recognition is not allowed in block 622. The enabling or disabling option is selectable by the user through the use of a feature that allows a user to customize settings for an application program or system software 124. This type of customization feature is well known in the art. Alternatively, a programmer may default the enabling/disabling ON or OFF, and not allow the user to choose whether to enable or disable interpreters 125. When the interpreters are disabled, then the user's touch input is processed as though the interpreters are not included in system software 124.

In another embodiment, interpreters 125 automatically recognize text that appears on display device 108 and therefore does not require the user to select text to be recognized. In a further embodiment, a user may access a list of available interpreters 125 and choose which interpreters 125 to disable or enable, and whether a particular interpreter 125 should recognize text automatically or only when text is selected by a user.

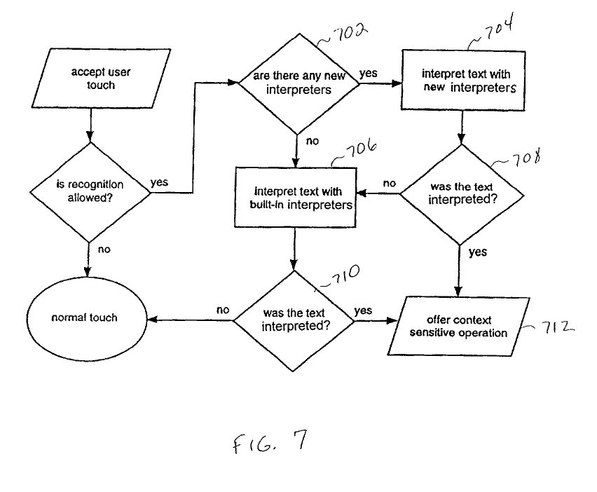

An alternate embodiment of the present invention is shown in FIG. 7 as providing a shell structure that allows the user to add custom interpreters 125 that take precedence over of one or more built-in interpreters 125. Block 702 tests whether any new interpreters 125 have been added. This indication is set by a programmer who adds interpreters 125 to the system software 124. When new interpreters 125 are present, they are used to interpret touch input from a user (block 704), otherwise, the built-in interpreters 125 are used (block 706). When new interpreters 125 are utilized, but the text touched by the user is not recognized (block 708), then the input is processed with built-in interpreters 125 (block 706). When the input is interpreted as a pre-defined type (blocks 708, 710), then the user is presented with the option to perform a context sensitive operation (block 712).

A further alternative embodiment is to provide the input from the user to all of the built-in interpreters 125 as well as the customized interpreters 125. Once each interpreter 125 has determined whether it recognizes the input, the user is presented with options for performing the context sensitive operations corresponding to each of the interpreters 125 that recognized the input. For example, the input may be a portion of a name of a city. The system may include one interpreter 125 that provides a map utility program using locations as input, and another interpreter 125 that provides a telephone directory when the name of a city is input. Options to view the city on a map, view a telephone directory for the city, and to edit the text are then presented to the user in a pop-up window. In one embodiment, pop-up window remains available until it is closed by the user so that the user can select an option, performs the desired functions with the application program, and return to the pop-up window to select another option. In an alternative embodiment, the pop-up window may be removed once the user selects an option.

A wide variety of interpreters 125 for recognizing input text and performing context sensitive operations are included within the scope of the present invention. Advantageously, a user may develop customized interpreters 125 for tasks which are frequently performed and/or which are unique to the industry in which the present invention is utilized. For example, an interpreter 125 capable of recognizing pharmaceutical names and presenting options for executing context sensitive operations pertaining to medical diagnosis, sales information, and/or dosage information may be provided. The interpreters 125 may present as many options for performing context sensitive operations as deemed appropriate. The interpreters 125 may also consider the context in which the text or object was displayed when determining which options to present to the user. For example, when the text is displayed while the user is accessing an electronic mail program, a different set of options for performing context sensitive operations may be presented compared to when the user is accessing a word processing program.

Further, the user may touch text, a portion of text, an object, or a portion of an object that appears anywhere on display device 108. The touched portion is input to one or more interpreters 125 that activate context sensitive operations when the input is recognized. Importantly, no advance preparation of the text or object is required, and no indication that the text may be selected to access a context sensitive operation is provided to the user. Text selection may be implemented so that a user may highlight all and/or just a portion of the text to be recognized.

While the invention has been described with respect to the embodiments and variations set forth above, these embodiments and variations are illustrative and the invention is not to be considered limited in scope to these embodiments and variations. Accordingly, various other embodiments and modifications and improvements not described herein may be within the spirit and scope of the present invention, as defined by the following claims.

What is claimed:

1. A computer system comprising:
a display device having a display area for displaying text; and
a memory having a set of program instructions stored therein, the program instructions having at least one pre-defined type of text, the program instructions being operable to recognize a portion of the text appearing on the display device as belonging to the at least one pre-defined type of text, and to present the user with an option for performing a context sensitive operation based on the recognized text.

2. The computer system, as set forth in claim 1, further comprising a user input device, wherein the user utilizes the input device to select text for the program instructions to recognize.

3. The computer system, as set forth in claim 1, wherein the program instructions are further operable to present an option to the user to enable and disable text recognition.

4. The computer system, as set forth in claim 1, wherein the program instructions are further operable to determine when the text is a date and to present an option for displaying the user's appointment calendar.

5. The computer system, as set forth in claim 1, wherein the program instructions are further operable to determine when the text is a telephone number and to present an option for dialing the telephone number.

6. The computer system, as set forth in claim 1, wherein the program instructions are further operable to determine when the text is a network address and to present an option for connecting to the network.

7. The computer system, as set forth in claim 6, wherein the program instructions are further operable to determine when the text is a world wide web address and to present an option for displaying the web page associated with the world wide web address.

8. The computer system, as set forth in claim 1, wherein the program instructions are further operable to determine when the text is a person's name and to present an option for contacting the person.

9. The computer system, as set forth in claim 1, wherein the program instructions are further operable to determine when the text is the name of a company and to present an option for contacting the company.

10. A computer program product comprising:
a computer readable medium storing program instructions, the program instructions having at least one pre-defined type of text, the program instructions being operable to output text for display on a display device, the program instructions being further operable to recognize the text as belonging to the at least one pre-defined type of text, and to present the user with an option for performing a context sensitive operation based on the recognized text.

11. The computer program product, as set forth in claim 10, wherein the user selects at least a portion of the text for the program instructions to recognize.

12. The computer program product, as set forth in claim 10, wherein the program instructions are further operable to present an option to the user to enable and disable text recognition.

13. The computer program product, as set forth in claim 10, wherein the program instructions are further operable to present an option to the user to automatically recognize the text as belonging to the at least one pre-defined type of text and to present an option to the user to enable and disable text recognition.

14. The computer program product, as set forth in claim 13, wherein the options to automatically recognize the text as belonging to the at least one pre-defined type of text and to enable and disable text recognition are presented in a pop-up window.

15. The computer program product, as set forth in claim 13, wherein the options to automatically recognize the text as belonging to the at least one pre-defined type of text and to enable and disable text recognition are presented in a pull-down menu.

16. The computer program product, as set forth in claim 13, wherein the options to automatically recognize the text as belonging to the at least one pre-defined type of text and to enable and disable text recognition are accessed utilizing an icon.

17. A method for assisting a user of a computer system in accessing computer program instructions, the method comprising:
pre-defining types of text;
accepting input by a user;
recognizing the input as selected text;
recognizing whether the selected text belongs to one of the pre-defined types of text; and
presenting at least one option for performing a context sensitive operation based on the selected text.

18. The method, as set forth in claim 17, further including presenting an option to the user to enable and disable text recognition.

19. The method, as set forth in claim 17, wherein recognizing whether text selected by a user belongs to one of the pre-defined types of text includes determining when the text is a date, and presenting options for tasks to perform based on the type of text includes an option for displaying the user's appointment calendar.

20. The method, as set forth in claim 17, wherein recognizing whether text selected by a user belongs to one of the pre-defined types of text includes determining when the text is a telephone number, and presenting options for tasks to perform based on the type of text includes an option for dialing the telephone number.

21. The method, as set forth in claim 17, wherein recognizing whether text selected by a user belongs to one of the pre-defined types of text includes determining when the text is an network address, and presenting options for tasks to perform based on the type of text includes an option for connecting to the network.

22. The method, as set forth in claim 21, wherein recognizing whether text selected by a user belongs to one of the pre-defined types of text includes determining when the text is a world wide web address, and presenting options for tasks to perform based on the type of text includes an option for displaying the web page associated with the world wide web address.

23. The method, as set forth in claim 17, wherein recognizing whether text selected by a user belongs to one of the pre-defined types of text includes determining when the text is a person's name, and presenting options for tasks to perform based on the type of text includes an option for contacting the person.

24. The method, as set forth in claim 17, wherein recognizing whether text selected by a user belongs to one of the pre-defined types of text includes determining when the text is a company's name, and presenting options for tasks to perform based on the type of text includes an option for contacting the company.

25. The method, as set forth in claim 17, further comprising presenting an option to the user to automatically recognize the text as belonging to the at least one pre-defined type of text; and
presenting an option to the user to enable and disable text recognition.

26. The method, as set forth in claim 25, further comprising presenting the options to automatically recognize the text as belonging to the at least one pre-defined type of text and to enable and disable text recognition in a pop-up window.

27. The method, as set forth in claim 25, further comprising presenting the options to automatically recognize the text as belonging to the at least one pre-defined type of text and to enable and disable text recognition in a pull-down menu.

28. The method, as set forth in claim 25, further comprising utilizing an icon to presenting the options to automatically recognize the text as belonging to the at least one pre-defined type of text and to enable and disable text recognition.

29. A computer program product comprising:
a computer readable medium storing program instructions, the program instructions having at least one built-in interpreter, the at least one built-in interpreter being operable to recognize whether input text belongs to a pre-defined type of text, and to present the user with an option for performing a context sensitive operation when the input text is recognized as belonging to the pre-defined type of text.

30. The computer program product, as set forth in claim 29, wherein the input text is generated based on a user touching a portion of text displayed on a display device.

31. The computer program product, as set forth in claim 30, wherein the program instructions further include a custom interpreter that is operable to recognize whether the input text belongs to a second pre-defined type of text, and to present the user with an option for performing a corresponding context sensitive operation when the input text is recognized as belonging to the second pre-defined type of text.

32. The computer program product, as set forth in claim 31, wherein the custom interpreter is executed prior to the at least one built-in interpreter.

33. The computer program product, as set forth in claim 32, wherein the at least one built-in interpreter is not executed when the custom interpreter recognizes the input text as the second pre-defined type of text.

34. The computer program product, as set forth in claim 33, wherein the program instructions include a plurality of custom interpreters and a plurality of built-in interpreters, wherein each custom interpreter and each built-in interpreter has a corresponding pre-defined type of text and a corresponding context sensitive operation, the program instructions being operable to present options for performing the corresponding context sensitive operation for each interpreter that recognizes the input text as the corresponding pre-defined type of text.

35. The computer program product, as set forth in claim 34, wherein the options are displayed in a pop-up window.

36. The computer program product, as set forth in claim 35, wherein the pop-up window is displayed until closed by the user so that the user can select one of the options, perform desired functions with the corresponding context sensitive operation, and return to the pop-up window to select another option.

37. The computer program product, as set forth in claim 35, wherein the pop-up window is removed when the user selects one of the options.
